(19) United States
(12) Patent Application Publication
(10) Pub. No.: US 2026/0193850 A1
(43) Pub. Date: Jul. 9, 2026

(54) Shock-Absorbing Surface and Methods of Making and Installing the Same

(71) Applicant: Great Southern Recreation, LLC, Murfreesboro, TN (US)

(72) Inventor: Justin Vance, Murfreesboro, TN (US)

(21) Appl. No.: 19/402,638

(22) Filed: Nov. 26, 2025

Related U.S. Application Data
(63) Continuation of application No. PCT/US2025/032383, filed on Jun. 5, 2025.
(60) Provisional application No. 63/742,772, filed on Jan. 7, 2025.

(51) Int. Cl. E01C 13/06; B32B 3/12; B32B 5/16; B32B 25/14; E01C 13/02; E01C 19/00

(52) U.S. Cl. CPC E01C 13/065; B32B 3/12; B32B 5/16; B32B 25/14; E01C 13/02; B32B 2264/0207; B32B 2307/56; B32B 2307/7376; E01C 19/00

(57) ABSTRACT

The present disclosure relates to an improved surface solution for use in or under a recreational space, such as a playground space. In specific embodiments, the presently disclosed impact-resistant surface is a multi-layered structure, wherein the layers include materials that provide a surface with an increased lifespan and optimal “critical fall height.” In various embodiments, the disclosure relates to a rubberized safety surface for public play spaces utilizing inter-cellular stabilization for loose-fill rubber granules in the impact course of the surface.

### CROSS-REFERENCE TO RELATED APPLICATIONS

This application is a continuation of PCT/US2025/032383, entitled “Shock-Absorbing Surface and Methods of Making and Installing the Same,” filed Jun. 5, 2025, which claims priority to U.S. Provisional Application No. 63/742,772, entitled “Shock-Absorbing Surface and Methods of Making and Installing the Same,” filed Jan. 7, 2025, the contents of each of which are incorporated herein by reference in its entirety.

All patents, patent applications, and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves all copyright rights.

### GOVERNMENT INTERESTS

N/A

### TECHNOLOGICAL FIELD

The present disclosure relates to a multi-layered, impact-resistant surface for use in or under a recreational space and methods of preparing the same. Specifically, the impact-resistant surface is configured to have an increased lifespan with an improved critical fall height (“CFH”) and simpler installation as compared to traditional play surfaces.

### BACKGROUND

This section is intended to introduce various aspects of the art, which may be associated with exemplary embodiments of the present disclosure. This discussion is believed to assist in providing a framework to facilitate a better understanding of aspects of the present disclosure. Accordingly, it should be understood that this section should be read in this light, and not necessarily as admissions of prior art.

Traditional playground surfaces use a rubber styrene butadiene (“SBR”)/buffing material blended with a urethane binder to achieve fall protection for playground users. This methodology is expensive and exhibits a diminishing return on attenuation after certain depths.

For instance, the materials and construction of traditional playground surfaces suffer from an inverse relationship between the CFH and the durability of the surface—as the depth of the cushion layer increases, the durability of the resultant product decreases. Thus, with traditional systems, the higher the CFH rating, the faster the resultant product deteriorates.

As a result of this inverse relationship, the maximum commercially viable CFH rating of traditional playground surfaces is typically about 12-14 feet. Accordingly, for playground owners to be compliant with most CFH ratings, such owners must limit the height of the equipment to about 12 feet. Alternatively, if a playground owner installs equipment that exceeds this CFH height, such owner assumes additional responsibility and risk in view of the non-compliant structures.

Traditional rubberized playground surfacing, such as a poured-in-place surface, often results in unpredictable and unreliable CFH ratings, primarily due to the on-site preparation of materials before installation. For example, many surfaces require that the installer mix SBR or rubber granules with a urethane binder at the site of installation to create a “cushion layer” with a specified CFH rating. This on-site mixing process is susceptible to human error, which can lead to variations in the CFH rating if the installer uses too much or too little urethane, resulting in unknown performance levels. Installers may measure dozens of consecutive batches during installation, and a single mismeasurement can cause the entire system to fail or to otherwise result in unreliable CFH ratings. Additionally, inconsistencies in raw materials, such as varying dust content between different units, can lead to differences in the final product, potentially causing failure. Surfacing products produced on site are also susceptible to environmental factors, including temperature and exposure to direct light, which can also affect the system's performance following installation.

Moreover, many traditional playground surfaces have a top layer or “wear course” that comprises a single layer of ethylene propylene diene monomer (“EPDM”), which, due to cost restrictions, is installed at maximum depth of about ⅜″ over the top of an SBR base. Such a top surface is prone to rapid deconstruction and deterioration during use.

In view of the foregoing, there is a need for a pre-manufactured impact-resistant surface for use with recreational areas that is easy to install and can achieve a CFH of greater than 12 feet while maintaining long-term durability.

### SUMMARY OF THE INVENTION

Disclosed herein is an improved surface solution for use in or under a recreational space, such as a playground space. In specific embodiments, the presently disclosed impact-resistant surface comprises a multi-layered structure, wherein the layers are comprised of materials that synergistically provide a surface with an increased lifespan and optimal “critical fall height.” In various embodiments, the disclosure relates to a rubberized safety surface for public play spaces utilizing inter-cellular stabilization for loose-fill rubber granules in the impact course of the surface as opposed to the traditional rubber buffing/urethane binder mix.

In one aspect, disclosed herein is a method of producing an improved impact-resistant surface. In embodiments, the method comprises installing a cellular matrix over a foundation to create a plurality of empty cells; filling the plurality of empty cells with impact granules to create a cushion layer; installing a topcoat over a top surface of the cushion layer, wherein the topcoat forms the top surface of the impact-resistant surface; or any combination thereof.

The step of installing the topcoat can comprise installing a containment layer over the top surface of the cushion layer; and installing a wear layer over a top surface of the containment layer, wherein the containment layer and the wear layer form the topcoat.

In embodiments, the topcoat is installed at a height of between ¾ inches to 1 inch over the cushion layer. The containment layer can be installed at a depth of about ⅝ inches. The wear layer can be installed at a depth of about ½ inches. In certain embodiments, the containment layer is installed at a depth of about ⅝ inches and the wear layer is installed at a depth of about ½ inches.

The method can further comprise the step of leveling the impact granules along a top surface of the cellular matrix. In embodiments, the method comprises the step of leveling the containment layer over the top surface of the cushion layer. The method can further comprise leveling the wear layer over the top surface of the cushion layer.

In certain embodiments, the cushion layer does not comprise urethane. The containment layer, the wear layer, or both can comprise ethylene propylene diene monomer (“EPDM”), artificial turf, or a combination thereof.

In various embodiments, the impact-resistant surface is installed beneath a playground area.

In certain embodiments, the foundation comprises a compacted crushed stone.

In another aspect, the present disclosure relates to a multi-layered, impact-resistant surface configured for use under a recreational area. The impact-resistant surface can comprise a topcoat, and a cushion layer, wherein the cushion layer is disposed beneath the topcoat. In certain embodiments, the cushion layer comprises a cellular matrix with a plurality granule-filled cells. The topcoat can comprise a containment layer disposed over the cellular matrix and a wear layer disposed over the containment layer such that the wear layer forms a top surface of the impact-resistant surface.

In various embodiments, the impact-resistant surface has a critical fall height of between about 12 feet and about 20 feet. The impact-resistant surface can have a critical fall height of up to about 18 feet.

In certain embodiments, the containment layer, the wear layer, or both comprise ethylene propylene diene monomer (“EPDM”), artificial turf, or a combination thereof.

In various embodiments, impact-resistant surface does not comprise urethane. The wear layer can comprise a thickness of about ½ inch and the containment layer has a thickness of about ⅝ inches. In certain embodiments, the cushion layer comprises a thickness of between about 1 inch and about 6 inches.

Other objects and advantages of this invention will become readily apparent from the ensuing description.

### BRIEF DESCRIPTION OF THE FIGURES

Certain illustrations, charts, or flow charts are provided to allow for a better understanding for the present invention. It is to be noted, however, that the drawings illustrate only selected embodiments of the inventions and are therefore not to be considered limiting of scope. Additional and equally effective embodiments and applications of the present invention exist.

FIG. 1 shows a top perspective and cut-away view of an impact-resistant surface in accordance with one embodiment of the present disclosure. A cellular matrix is partially filled with loose-fill granules to form a cushion layer or “impact course” that is shown resting on a foundational layer. A topcoat or “wear course” is shown partially extending over the cushion layer.

FIG. 2A provides a cross-sectional side view of an impact-resistant surface under another embodiment. This embodiment shows an impact-resistant surface with a dual-layer topcoat and a cushion layer that includes a cellular matrix that is filled with loose-fill granules.

FIG. 2B provides a cross-sectional side view of an impact-resistant surface under an additional embodiment. This embodiment shows an impact-resistant surface with a dual-layer topcoat, a cushion layer, and a dividing barrier disposed between the cushion layer and the foundation upon which the impact-resistant surface sits.

FIG. 3 shows a flow diagram of a method of installing an impact-resistant surface in accordance with another embodiment of the present disclosure.

### DETAILED DESCRIPTION OF THE INVENTION

### Abbreviations and Definitions

Detailed descriptions of one or more embodiments are provided herein. It is to be understood, however, that the present invention can be embodied in various forms. Therefore, specific details disclosed herein are not to be interpreted as limiting, but rather as a basis for the claims and as a representative basis for teaching one skilled in the art to employ the present invention in any appropriate manner.

The singular forms “a,” “an,” and “the” include plural reference unless the context clearly dictates otherwise. The use of the word “a” or “an” when used in conjunction with the term “comprising” in the claims and/or the specification can mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited. Therefore, for example, the phrase “wherein the lever extends vertically” means “wherein the lever extends substantially vertically” so long as a precise vertical arrangement is not necessary for the lever to perform its function.

The terms “comprising” and “including” and “having” and “involving” (and similarly “comprises,” “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b, and c. Wherever the terms “a” or “an” are used, “one or more” is understood, unless such interpretation is nonsensical in context.

As used herein the term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

As used herein, the phrase “impact-resistant surface,” “shock-absorbing surface,” and the like can refer to any resilient surface or floor configured to absorb and distribute the energy from an impact or collision and reduce the likelihood of injury to an individual when falling thereon. The impact-resistant surfaces disclosed herein can be comprised of materials that return to their original shape after being compressed or deformed. In embodiments, an impact-resistant surface is comprised of materials configured to withstand repeated forces of impacts or collisions over time without breaking, cracking, or showing significant damage.

The phrase “artificial turf,” as used herein can refer to a ground-covering material comprising synthetic fibers or filaments configured to simulate the appearance or texture of natural grass. Artificial turf can include a backing layer to which the fibers are attached. In certain embodiments, the artificial turf includes infill materials, such as sand, rubber, or polymeric particles. In embodiments, the fibers of the artificial turf are formed from polyethylene, polypropylene, nylon, or other suitable polymers, and may vary in length, density, and configuration. Examples of artificial turf include, but are not limited to, synthetic grass, synthetic turf, artificial grass, fake grass, man-made turf, engineered grass, imitation turf, turf carpet, polymeric grass, or any other non-natural turf system currently known or later developed in the art.

### Description of Selected Embodiments

Disclosed herein is a multi-layered, impact-resistant surface or flooring comprising a topcoat and a cushion layer. In embodiments, the impact-resistant surface is configured to provide an improved surface solution for use in or under a recreational space, such as a playground. As compared to traditional play surfaces, the presently disclosed surface achieves a greater CFH rating, an increased lifespan, and simpler installation.

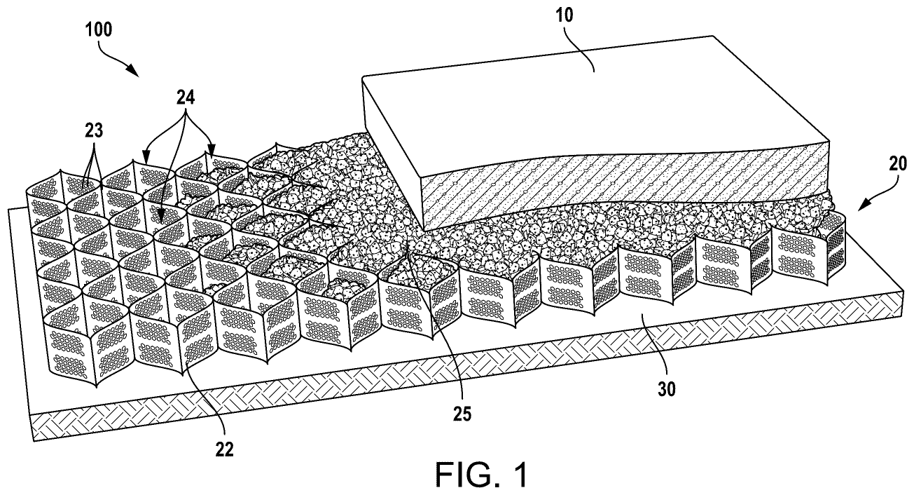

With reference to FIG. 1, the presently disclosed impact-resistant surface 100 comprises a cushion layer 20 that rests on top of the foundation 30. In embodiments, the cushion layer 20 is covered by a topcoat 10.

As can be seen, the cushion layer 20 can comprise a support structure or frame that forms a cellular matrix 22 with impact granules 25 disposed therein. In various embodiments, the cellular matrix 22 defines a plurality of open cells 24 configured to hold a plurality of impact granules 25. In embodiments, one or more of the open cells 24 are filled with impact granules 25. In specific embodiments, each of the open cells 24 are substantially filled with impact granules 25. The impact granules 25 can be filled to the tops of each of the one or more cells 24 such that the impact granules are substantially level with the top of the cellular matrix 22. In embodiments, the cells 24 are overfilled such that the impact granules 25 extend above the cells and on top of the cellular matrix 22.

In certain embodiments, at least one wall of the cellular matrix 22 is permeable to bulk water and water vapor such that standing water can drain in the lateral direction across the walls of the cellular matrix 22. By way of example, one or more walls of the cellular matrix 22 can comprise a plurality of pores, holes, or gaps 23 to permit water to pass therethrough. In alternate embodiments, the cellular matrix 22 comprises a woven or non-woven fabric. The largest diameter of the pores 23 of the cellular matrix 22 can be smaller than the smallest diameter of the impact granules 25. In certain embodiments, the cellular matrix 22 comprises a film, net, or mesh-like structure. In various embodiments, the cushion layer 22 does not comprise urethane and does not need to be mixed or otherwise prepared on-site.

As shown in FIG. 1, the topcoat 10 can be placed on top of the cushion layer 20 to contain the impact granules 25 within the cells 24 of the cellular matrix 22. In embodiments, the topcoat 10 is configured to cover the entire top surface of the cushion layer 20.

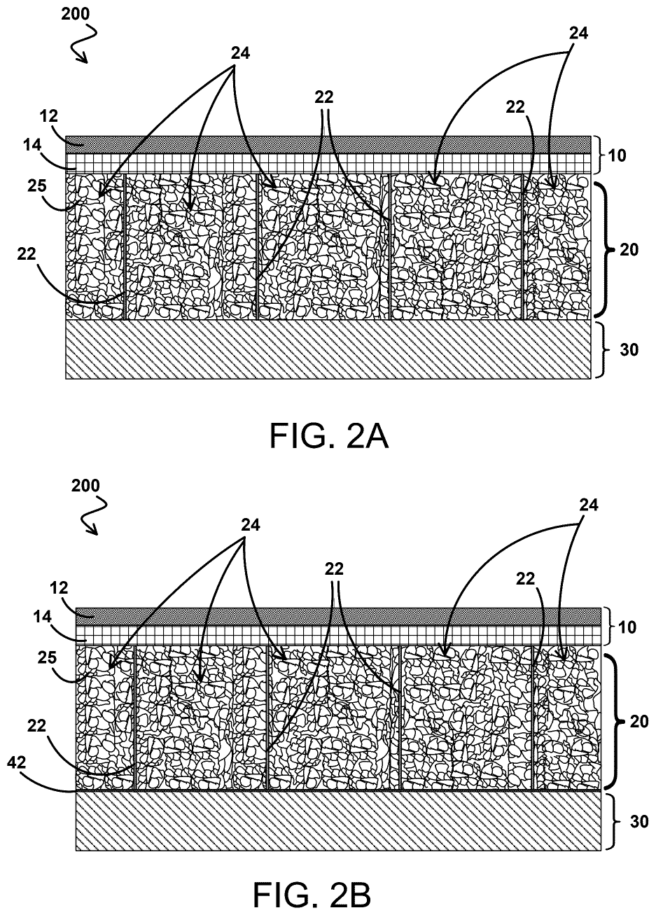

FIG. 2A shows a cross-sectional side view of an impact-resistant surface 200 under another embodiment. This embodiment shows an impact-resistant surface 200 with a dual-layer topcoat 10 and a cushion layer 20 that includes a cellular matrix 22 that is filled with loose-fill granules 25. The impact-resistant surface 200 is shown resting on a foundation 30.

FIG. 2B shows a cross-sectional side view of an impact-resistant surface 200 under an additional embodiment. This embodiment shows an impact-resistant surface 200 with a dual-layer topcoat 10 and a cushion layer 20 that includes a cellular matrix 22 filled with loose-fill granules 25. The impact-resistant surface 200 is shown resting on a foundation 30 with a dividing barrier 42 disposed between the cushion layer 20 and the foundation 30.

In the embodiments of FIGS. 2A and 2B, the topcoat 10 comprises a containment layer 14 configured to cover the cushion layer 20 and a wear layer 12 that is placed on top of the cushion layer 14. Thus, the containment layer 14 sits within the topcoat 10 between the wear layer 12 on the upper surface and the cushion layer 20 on the lower surface and prevents the displacement of impact granules 25 from the cells 24 of the cellular matrix 22. Such a configuration maintains the impact granules 25 within the cells 24 during use to create a resilient and durable cushion that can maintain a consistent CFH rating of at least 18 feet for extended periods.

The wear layer 12 can be disposed on top of the containment layer 14 such that the wear layer 12 is the only portion of the topcoat 10 that is directly exposed to environmental elements and visible to a user. In certain embodiments, the wear layer 12 can be removed from the topcoat 10 and replaced as necessary. Such a configuration permits the containment layer 14 portion of the topcoat 10 to remain in place over the cushion layer 20 when the wear layer 12 is replaced. Thus, the present disclosure provides a means for replacing only a portion of the topcoat 10 without disturbing or otherwise affecting the quality or function of the cushion layer 20.

In embodiments, the wear layer 12 and the containment layer 14 comprise substantially similar materials. The wear layer 12 and the containment layer 14 can comprise different materials. In embodiments, the wear layer 12, the containment layer 14, or both comprise EPDM, artificial turf, or a combination thereof. In embodiments, both layers of the topcoat 10 comprise EPDM. One or more of the topcoat 10 layers 12, 14 can comprise EPDM granules. In alternate embodiments, the wear layer 12 comprise artificial turf. In embodiments, both layers of the topcoat 10 comprise EPDM. One or more of the topcoat 10 layers 12, 14 can comprise artificial turf.

The topcoat 10 can comprise any depth or thickness that is sufficient to (1) contain the impact granules 25 within the cushion layer 20 and (2) provide a durable external wear course layer. In embodiments, the topcoat 10 comprises a thickness of up to about 2 inches. The topcoat 10 can have a thickness of up to about 1.5 inches. The thickness of the presently disclosed surface system can be between about 1 inch to about 1.5 inches. The topcoat 10 can be about ¾ inches. In certain embodiments, the topcoat 10 is less than about 1 inch. The topcoat 10 can be about 0.7 inches, about 0.8 inches, about 0.9 inches, about 1.0 inches, about 1.1 inches, about 1.2 inches, about 1.3 inches, about 1.4 inches, about 1.5 inches, about 1.6 inches, or about 1.7 inches.

The containment layer 14 can be up to about 1 inch thick. In embodiments, the containment layer 14 is up to about ¾ inches thick. The containment layer 14 can be up to about ⅝ inches thick. In certain embodiments, the containment layer 14 is less than ½ inches thick.

The wear layer 12 can be up to about 1 inch thick. In embodiments, the wear layer 12 is up to about ¾ inches thick. The wear layer 12 can be up to about ⅝ inches thick. In certain embodiments, the wear layer 12 is about ½ inches thick. The wear layer 12 can be less than about ½ inches thick.

In one embodiment, the containment layer 14 is about ⅝ inches thick and the wear layer 12 is about ½ inch thick. The wear layer 12, the containment layer 14, or both can comprise up to about 50% of the thickness of the topcoat 10. In embodiments, the wear layer 12 is thicker than the containment layer 14. In an alternative embodiment, the containment layer 14 is thicker than the wear layer 12.

As discussed in the embodiments above, the cushion layer 20 comprises an inter-cellular support structure or frame 22 and loose-fill granules or fragments 25 comprising a compressible or resilient material. Thus, in the presently disclosed surface system 100, 200, the cushion layer 20 employs a unique solution—cellular stability provided by the membrane 24 and dry chunk impact granules 125. to avoid the use of urethane and the problems associated with traditional poured-in-place surfaces.

The cushion layer 22 can be comprised of components that are manufactured prior to installation such that the installer is not required to prepare, measure, or otherwise mix components to create the cushion layer 22. In embodiments, the lack of urethane in the cushion layer 20 avoids the difficulties traditional play surfaces face in achieving a CFH of more than 12 feet while also providing a durable surface that maintains a consistent CFH with repeated use. The presently disclosed surface system 100, 200 solves this by using the impact granules 25 (such as chunk rubber) and the cellular matrix 22. In operation, the impact granules 25 produce an increased CFH at a lower depth as compared to traditional playground surfaces, and the cellular matrix 22 introduces stability within and between the cells 24, which prevents the impact granules 25 from being displaced or otherwise move within the impact-resistance surface 100, 200.

In embodiments, the loose-fill granules 25 are comprised of rubber. The intercellular support structure or frame 22 can be configured to be placed directly on a foundation 30. The foundation 30 can be compacted earth, a substrate of crushed stone (e.g., a crusted stone compacted to 95%), or other base layer known in the industry. The intercellular support structure 22 can provide a structure for receiving and holding the loose fill rubber granules 25.

As shown in FIG. 2B, in certain embodiments, a dividing barrier 42 is disposed between the cushion layer 20 and the foundation 30. The dividing barrier 42 can provide stability to the cushion layer 20. In embodiments wherein the foundation 30 comprises compacted earth, crushed and compacted stone, another base layer known in the industry, or any combination thereof, the dividing barrier 42 prevents portions of uncompacted or loose foundation material from intermingling with the impact granules 25 of the cushion layer 20. The dividing barrier 42 can be permeable to bulk water such that water will drain from the cushion layer 20 and through the dividing barrier 42 during use. By way of example, the dividing barrier 42 can comprise a porous material to permit water to pass therethrough. In certain embodiments, the dividing barrier 42 comprises a woven or non-woven fabric. The largest diameter of any pore or gap within the dividing barrier 42 can be smaller than the smallest diameter of the impact granules 25. The pores of the dividing barrier 42 can be smaller than the smallest diameter of any loose or uncompacted portion of the foundation 30. Thus, the dividing barrier 42 can provide a permeable interface between the cushion layer 20 and the foundation 30. In certain embodiments, the dividing barrier 42 comprises a filter fabric. The dividing barrier 42 can comprise a non-woven, 8 oz fabric. The filter fabric can be any filter fabric intended for use in a commercial construction environment.

The thickness of the cushion layer 20 can be directly proportional to the CFH of the resultant impact-resistant layer 100, 200. In embodiments, the cushion layer 20 is between about 1 inch thick to about 6 inches thick. The cushion layer 20 can be up to about 8 inches thick. In embodiments, the cushion layer 20 can be as thin as about 0.5 inches. The cushion layer 20 can be about 1.0 inch thick, about 1.5 inches thick, about 2.0 inches thick, about 2.5 inches thick, about 3.0 inches thick, about 3.5 inches thick, about 4.00 inches thick, about 4.5 inches thick, about 5.0 inches thick, about 5.5 inches thick, about 6.0 inches thick, about 6.5 inches thick, about 7.0 inches thick, about 7.5 inches thick, or about 8.0 inches thick.

In embodiments, the combination of the dual-layer topcoat 10, the inter-cellular support structure 22, and the loose fill rubber granules 25 increases the durability of the impact-resistant surface while also improving the ability of the surface to absorb impact energy of a fall and reduce the risk of user injuries. In embodiments, the impact-resistant surface 100, 200 provides for a CFH rating of at least 18 feet, which is at least 6 feet higher than traditional surfaces used in the playground industry.

As discussed above, embodiments of the presently disclosed surface system do not use urethane in the construction of the cushion layer 20. Rather, the present surface system 100, 200 utilizes pre-engineered components to addresses certain “field-risks” (e.g., risks that occur due to human error due to mismeasurements in mixing, variations in ingredients, and contaminants such as dust content, environmental fluctuations, etc.). In addition to eliminating risks due to preparation of materials in the field, the use of pre-engineered components in the presently disclosed system 100, 200 significantly simplifies the process for installation of the impact-resistant surface.

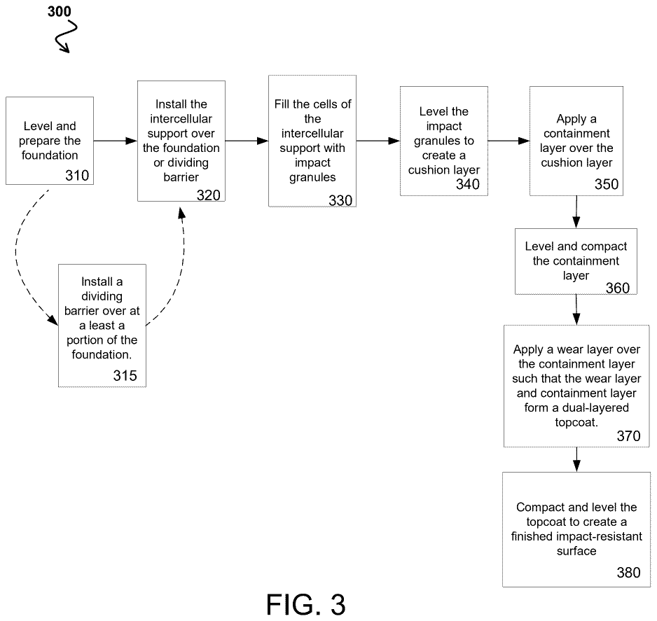

FIG. 3 shows a flow diagram of a method 300 of installing an impact-resistant surface 100, 200 in accordance with another aspect of the present disclosure. In embodiments, the method comprises a step of leveling and preparing the foundation 310. In one embodiment, this foundation leveling and preparing step 310 comprises compacting the earth under the area where the playground surface will be installed. The foundation leveling and preparation step 310 can include spreading a crushed stone (such as an engineered crushed stone) over the area where the playground surface will be installed and compacting the crushed stone. In certain embodiments, the method includes an installing a dividing barrier 42 over at a least a portion of the foundation 30. The method can further include the step 320 of installing an intracellular support 22 over the foundation 30 or the dividing barrier 42. The step of installing the intercellular support matrix over the foundation 320 can comprise anchoring the intercellular support matrix 22 along at least one point on to the foundation 30 and spreading the intercellular support matrix 22 across at least a portion of the foundation 30 such that the walls of the support matrix 22 define a plurality of cells 24. An additional step 330 of the present embodiment 300 includes filling one or more cells 24 of the intercellular support matrix 22 with impact granules 25. In embodiments, impact granules 25 are placed in substantially all of the cells 24 of the intercellular support matrix 22. Impact granules 25 can be filled up to the top of the walls of the cells 24 within the support matrix 22. In certain embodiments, this step 330 includes overfilling a plurality of cells 24 with impact granules 25. The method can further comprise the step 340 of leveling the impact granules 25 over the cellular matrix 22 to create a cushion layer 20. In certain embodiments, the impact granules 25 are compacted via methods known in the art.

The presently disclosed method 300 can further comprise the step 350 of substantially covering a top surface of the finished cushion layer 20 with a containment layer 14. In embodiments, the containment layer 14 is leveled, compacted, or both 360 over the cushion layer 20 to form a finished containment layer 14. The method 300 can further include the step 370 of substantially covering a top surface of the containment layer 14 with a wear layer 12, which will form a top surface of the impact-resistant layer 100, 200. The method 300 can also include the step 380 of leveling the wear layer 312 over the containment layer 314, compacting the wear layer 412 over the containment layer 314, or both to create the topcoat 310 of the impact-resistant surface 100, 200.

Exemplary features and benefits of the present disclosure include but are not limited to: (i) improved performance and durability over time as compared to traditional playground surfaces; (ii) simple, reliable, and reproducible installation; (iii) enhanced protection against “filed risks” that occur during on-site preparation of the surface layer; and (iv) improved CFH and user protection.

One or more of the cells 24 can have an enclosed shape. The cells 24 can be in any conceivable shape or form. In embodiments, the shape of at least one of the cells 24 is a triangle, square, rectangle, rhombus, parallelogram, trapezoid, pentagon, hexagon, heptagon, octagon, nonagon, decagon, circle, oval, half circle, or a quarter circle. The shape of the cells 24 can comprise a curve. In certain embodiments, the cellular matrix 22 can comprise collapsible cells 24 such that the cellular matrix 22 can be compressed for packing and transportation and then expanded over a foundation 30 during installation of the impact-resistant surface 100, 200.

The presently disclosed, impact-resistant surface 100, 200 can be used as a floor in any commercial or residential setting to reduce the risk of injury in the event of a fall. The impact-resistant surface 100, 200 disclosed herein can be useful as a floor to reduce the stress on an individual's spine, knees, ankles, and joints when running, jumping, or walking thereon. In various embodiments, the presently disclosed shock-absorbing surface 100, 200 is configured for use under playground equipment, as outdoor or indoor running tracks, as flooring for gymnasiums, retail stores, commercial kitchens, assembly lines, factories, restaurants, hospitals, nursing homes, or other commercial or private settings with an increased risk of injury due to falls.

### EXAMPLES

Examples are provided below to facilitate a more complete understanding of the invention. The following examples illustrate the exemplary modes of practicing the invention. However, the scope of the invention is not limited to specific embodiments disclosed in these Examples, which are for purposes of illustration only, since alternative methods can be utilized to obtain similar results.

### Example 1

The present disclosure relates to an improved surface solution for use in or under a recreational space, such as a playground space. As compared to traditional play surfaces, the presently disclosed surface achieves a greater “critical fall height” rating, and increased lifespan/performance. In various embodiments, the disclosure relates to a rubberized safety surface for public play spaces utilizing inter-cellular stabilization for loose-fill rubber granules in the “impact course” of the surface as opposed to the traditional rubber buffing/urethane binder mix.

Many surfaces use a rubber styrene butadiene rubber (“SBR”)/buffing material blended with a urethane binder to achieve fall protection for playground users. This methodology is expensive and shows a diminishing return on attenuation after certain depths. The currently disclosed system provides a more cost-effective option that will last much longer and can achieve higher critical fall height (“CFH”) ratings as compared to surfaces that are currently on the market.

The maximum CFH of most playground surfaces is about 14 feet, which either (i) limits the height of playground equipment to 14 feet or (ii) forces a playground owner to assume additional responsibility should the owner install non-compliant equipment that exceeds this safety standard.

In certain embodiments, the present systems employes loose rubber granules disposed within a matrix of interconnected cells to achieve surfaces with CFH ratings of up to 18 feet.

Standard rubberized playground surfacing is unpredictable. It relies on an installer to properly mix a urethane binder with a post-consumer “SBR” rubber buffing in the “cushion” layer to produce a nominal Critical Fall Height rating. Three problems are inherent in the cushion layer of traditional rubber surfaces:
1. A significant portion of manufacturing a traditional rubber surface system occurs on-site and in the field. This is problematic as the installer will often use too much or too little urethane resulting in an unknown level of performance. Often, the installer is weighing dozens of consecutive batches during the installation. If even one is mismeasured, the system can fail. In addition, there are often variances in the raw materials that are delivered to site. If one bag contains more dust than the other, the resultant yield will be less, and the finally installed system can fail. Further, environmental factors including, but not limited to shade and temperature can also impact the performance of the system.
   A. The presently disclosed surface system addresses this “field-risk” by removing urethane from the cushion layer. Not only does this simplify the construction of this most important layer, but it also removes the installer-risk and utilizes only pre-engineered elements in its construction.
2. The first place a rubber surface fails is in the “wear course. Typically, the wear course is a single layer of EPDM granule and is installed at a ⅜″ depth over the top of a standard SBR base.
   A. The presently disclosed surface system utilizes a dual-layer system. The first is a ⅝″ thick containment layer. This layer covers and secures the stabilization membrane and the chunk rubber below. The second layer is the colorful, “wear layer” installed at a ½″ depth. This two-layer system contains and protects the cushion layer beneath allowing the system to have an increased lifespan and performance.
3. It's very difficult to achieve a critical fall height rating of more than 12′ while also producing a surface that performs well over time. As the installer increases the depth of the surface to make it softer, there's an inverse relationship to its longevity.
   A. The presently disclosed surface system solves this by using the chunk rubber and the membrane. The chunk rubber produces a better fall height at a lower depth and the membrane introduces cellular stability keeping the chunk rubber from moving around.

The presently disclosed surface system relies on a unique solution in its cushion layer—cellular stability provided by the membrane—and dry (no urethane) chunk rubber. This cushion layer is then capped with a unique dual-layer system. EPDM granules installed at a ⅝″ depth to contain and encapsulate the cushion layer and then a wear course of ½″ EPDM that's visible to the user. In alternate embodiments, the wear course comprises artificial turf that is visible to a user. The artificial turf can be installed a depth of about ½″.

Exemplary features and benefits of the present disclosure include but are not limited to greater performance over time as compared to traditional playground surfaces; simple, reliable, and reproducible installation; enhanced protection against “filed risks” that occur during on-site preparation of the surface layer; and improved CFH and user protection.

In various embodiments, the presently disclosed shock-absorbing surface is configured for use under commercial playground equipment in public play spaces.

### EQUIVALENTS

Those skilled in the art will recognize, or be able to ascertain, using no more than routine experimentation, numerous equivalents to the specific substances and procedures described herein. Such equivalents are considered to be within the scope of this invention and are covered by the following claims.

What is claimed:

1. A method of producing an improved impact-resistant surface, comprising the steps of:
installing a cellular matrix over a foundation to create a plurality of empty cells;
filling the plurality of empty cells with impact granules to create a cushion layer;
installing a topcoat over a top surface of the cushion layer, wherein the topcoat forms the top surface of the impact-resistant surface.

2. The method of claim 1, wherein the step of installing the topcoat comprises:
installing a containment layer over the top surface of the cushion layer; and
installing a wear layer over a top surface of the containment layer, wherein the containment layer and the wear layer form the topcoat.

3. The method of claim 1, wherein the topcoat is installed at a height of between ¾ inches to 1 inch over the cushion layer.

4. The method of claim 2, wherein the containment layer is installed at a depth of about ⅝ inches.

5. The method of claim 2, wherein the wear layer is installed at a depth of about ½ inches.

6. The method of claim 1, wherein the containment layer is installed at a depth of about ⅝ inches and the wear layer is installed at a depth of about ½ inches.

7. The method of claim 1, further comprising the step of leveling the impact granules along a top surface of the cellular matrix.

8. The method of claim 1, further comprising the step of leveling the containment layer over the top surface of the cushion layer.

9. The method of claim 1, further comprising the step of installing a dividing barrier over the foundation.

10. The method of claim 1, wherein the cushion layer does not comprise urethane.

11. The method of claim 1, wherein the containment layer, the wear layer, or both comprise ethylene propylene diene monomer (“EPDM”), artificial turf, or a combination thereof.

12. The method of claim 1, wherein the impact-resistant surface is installed beneath a playground area.

13. The method of claim 1, wherein the foundation comprises a compacted crushed stone.

14. A multi-layered, impact-resistant surface configured for use under a recreational area comprising:
a topcoat, and a cushion layer, wherein the cushion layer is disposed beneath the topcoat;
the cushion layer comprising a cellular matrix with a plurality granule-filled cells;
the topcoat comprising:
a containment layer disposed over the cellular matrix; and
a wear layer disposed over the containment layer such that the wear layer forms a top surface of the impact-resistant surface.

15. The impact-resistant surface of claim 14 having a critical fall height of between about 12 feet and about 20 feet.

16. The impact-resistant surface of claim 15 having a critical fall height of up to about 18 feet.

17. The impact-resistant surface of claim 14, wherein the containment layer, the wear layer, or both comprise ethylene propylene diene monomer (“EPDM”), artificial turf, or a combination thereof.

18. The impact-resistant surface of claim 14, wherein the impact-resistant surface does not comprise urethane.

19. The impact-resistant surface of claim 14, wherein the wear layer comprises a thickness of about ½ inch and the containment layer has a thickness of about ⅝ inches.

20. The impact-resistant surface of claim 19, wherein the cushion layer comprises a thickness of between about 1 inch and about 6 inches.
